(19) United States
(12) Patent Application Publication
(10) Pub. No.: US 2015/0202710 A1
(43) Pub. Date: Jul. 23, 2015

(54) METHOD OF WELDING STRUCTURAL STEEL AND WELDED STEEL STRUCTURE

(71) Applicants: Mitsuyoshi Nakatani, Osaka (JP); Masamitsu Abe, Osaka (JP); Junya Yamada, Osaka (JP)

(72) Inventors: Mitsuyoshi Nakatani, Osaka (JP); Masamitsu Abe, Osaka (JP); Junya Yamada, Osaka (JP)

(73) Assignee: HITACHI ZOSEN CORPORATION, Osaka (JP)

(21) Appl. No.: 14/370,111

(22) PCT Filed: Mar. 21, 2013
(86) PCT No.: PCT/JP2013/001898

§ 371 Date: Jul. 1, 2014

(30) Foreign Application Priority Data
Mar. 22, 2012 (JP) 2012-066282

(51) Int. Cl. B23K 9/23; C22C 38/24; C22C 38/22; B23K 9/18; B23K 31/02

(52) U.S. Cl. CPC B23K 9/23; B23K 9/186; B23K 31/02; C22C 38/22; C22C 38/24

(57) ABSTRACT

A method of welding structural steel containing, by mass %, Cr: 1.5 to 3.5%, Mo: 0.5 to 1.5%, and V: 0.15 to 0.5%. It comprises preheating joint of the structural steel to be welded at temperatures of 150 to 250 degrees Celsius; multilayer welding the joint end portions; keeping the interpass temperature of the joint end portions during the multilayer welding at 150 to 350 degrees Celsius; then after welding completion, performing DHT by heat treating the weld zone before cooling down below 150 degrees Celsius under the conditions that the temperature is 250 to 340 degrees Celsius and that the treatment time is 5 to 10 hours.

### TECHNICAL FIELD

The present invention relates to a method of welding a Cr—Mo—V steel which can adapt to high-temperature, high-pressure conditions and a welded steel structure welding by this method.

### BACKGROUND ART

Cr—Mo steels containing Cr and Mo are used in consideration of uses at high temperatures and high pressures as steel used in structures, such as pressure vessels. In recent years, operating conditions have had a tendency toward higher temperatures and higher pressures than before in order to ensure production efficiency. For this reason, structural steel having wall thicknesses larger than before are used, resulting in increased material costs and production costs. On the other hand, Cr—Mo—V steels obtained by adding vanadium to Cr—Mo steels have good high-temperature strength and hydrogen attack resistance and in addition, Cr—Mo—V steels can apply high-pressure conditions. Therefore, Cr—Mo—V steels have come to be used as structural steel for desulfurization reactors in oil refinery plants and steam turbines as described in Patent Literature 1. However, in the case of Cr—Mo—V steels with wall thicknesses of more than 100 mm, for example, multilayer welding is performed in assembling structures and, therefore, the danger of cold cracking (delayed cracking) due to diffusible hydrogen is concerned.

In welding sites, dehydrogenation heat treatment (DHT) is performed as heating before the cooling of a weld zone in order to reduce the amount of diffusible hydrogen in the weld zone. In this DHT, as stated in the API standard described in Non-Patent Literature 1, it is recommended that the treatment be carried out at a temperature of 350 degrees Celsius for a treatment time of 4 hours. It has been ascertained that when DHT is performed under these conditions, the amount of diffusible hydrogen in a weld zone decreases, and the danger of cold cracking decreases also.

### CITATION LIST

### Patent Literature

[PLT 1] Japanese Patent Laid-Open No. 8-209293

Non Patent Literature

[NPL 1] API Recommended Practice 934-A Second Edition, 2008

### SUMMARY OF INVENTION

### Technical Problem

In subjecting a weld zone of a large steel structure to DHT, it is not easy to keep the weld zone for a long time at a temperature of 350 degrees Celsius through the use of a gas burner. For this reason, a heat treatment device, such as an electric heater and a heat treatment furnace, suited to the size of the steel structure becomes necessary and, in particular, in the case where the ambient temperature is low, it is necessary to install a heat insulating material. As a result, disadvantageously, this poses the problem that the size of the heat treatment device becomes large and that in addition, the process becomes complicated compared to the case where heat treatment is performed using a gas burner, leading to an increase in production costs.

Therefore, in view of the above-described problem in conventional technique, the present invention aims to provide a method of welding structural steel and a welded steel structure which can suppress an increase in manufacturing costs even in the case where a weld zone of large steel structural is subjected to DHT.

### Solution to Problem

The present inventors have intensively studied the heat treatment for suppressing cold cracking of a weld zone, which causes a problem in a steel structure made of a Cr—Mo—V steel, and as a result we have obtained a method of welding structural steel and a welded steel structure in which the cold cracking of a weld zone can be suppressed by performing DHT at lower temperatures than before.

That is, according to an aspect of the present invention, a method of welding a structural steel containing, by mass %, Cr: 1.5 to 3.5%, Mo: 0.5 to 1.5%, and V: 0.15 to 0.5%, includes preheating joint of the structural steel to be welded at temperatures of 150 to 250 degrees Celsius; multilayer welding the joint; keeping the interpass temperature of the joint during the multilayer welding at 150 to 350 degrees Celsius; and performing DHT by heat treating the weld zone kept at temperatures of not less than 150 degrees Celsius under the conditions that the temperature is 250 to 340 degrees Celsius and that the treatment time is 5 to 10 hours.

According to the present invention, the joint is preheated at temperatures of 150 to 250 degrees Celsius before submerged arc welding, the interpass temperature during multilayer welding is kept at 150 to 350 degrees Celsius, and when the weld zone kept at temperatures of not less than 150 degrees Celsius is subjected to DHT, the heat treatment is performed under the conditions that the temperature is 250 to 340 degrees Celsius and that the treatment time is 5 to 10 hours. Therefore, in subjecting a weld zone of large structural steel to DHT, it is possible to perform heating and heat treatment using a gas burner, for example. For this reason, heat treatment devices, such as a large electric heater and a heat treatment furnace, become unnecessary. In addition, the process can be simplified. As a result of this, it is possible to reduce production costs.

Because the interpass temperature of joint during the multilayer welding is 150 to 350 degrees Celsius, the coarsening of grains which causes the deterioration of the toughness of an affected zone by the welding heat is prevented and it is possible to further increase the suppressing effect of the cold cracking of a weld zone.

It is preferred that the above-described welding be performed by the submerged arc welding method for a butt joint. Structural steel can be joined together with good efficiency by adopting the submerged arc welding method for a butt joint.

A welded steel structure according to another aspect of the present invention is obtained by welding structural steel containing, by mass %, Cr: 1.5 to 3.5%, Mo: 0.5 to 1.5%, and V: 0.15 to 0.5%. Joint of the structural steel preheated to temperatures of 150 to 250 degrees Celsius is multilayer welded at interpass temperatures of 150 to 350 degrees Celsius and the resulting weld zone is subjected to DHT under the conditions that the temperature is 250 to 340 degrees Celsius and that the treatment time is 5 to 10 hours.

According to the present invention, the preheating is carried out at temperatures of 150 to 250 degrees Celsius before the welding, the interpass temperature during multilayer welding is kept at 150 to 350 degrees Celsius, and when the weld zone is subjected to DHT, the heat treatment is performed under the conditions that the temperature is 250 to 340 degrees Celsius and that the treatment time is 5 to 10 hours. Therefore, in subjecting a weld zone of large structural steel to DHT, it is possible to perform heating and heat treatment using a gas burner, for example. For this reason, heat treatment devices, such as a large electric heater and a heat treatment furnace, become unnecessary. In addition, the process can be simplified. As a result of this, it is possible to reduce production costs.

Because the interpass temperature during multilayer welding is 150 to 350 degrees Celsius, the coarsening of grains, which causes the deterioration of the toughness of an affected zone by the welding heat, is prevented and it is possible to further increase the suppressing effect of the cold cracking of a weld zone.

The wall thickness of the structural steel may be large, and for example, the welded steel structure is formed as a pressure vessel in the shape of a cylinder with wall thicknesses of 50 to 350 mm. Dehydrogenation can be performed by DHT at temperatures lower than before and it is possible to reduce production costs.

### Advantageous Effects of Invention

As described above, according to the present invention, heat treatment devices, such as a large electric heater and a heat treatment furnace, become unnecessary. In addition, the process can be simplified. Therefore, it is possible to reduce production costs.

### BRIEF DESCRIPTION OF DRAWINGS

FIG. 1 is a flowchart to explain the procedure for a method of welding structural steel in an embodiment of the present invention.

FIG. 2 is a diagram showing the method of welding structural steel. FIG. 2 (a) shows an example in which the method of welding structural steel is applied to the longitudinal outer-side welding of the structural steel. FIG. 2 (b) shows an example in which the method of welding structural steel is applied to the longitudinal inner-side welding of the structural steel.

FIG. 3 is a diagram showing the method of welding structural steel. FIG. 3 (a) shows an example in which the method of welding structural steel is applied to the circumferential outer-side welding of the structural steel. FIG. 3 (b) shows an example in which the method of welding structural steel is applied to the circumferential inner-side welding of the structural steel.

FIG. 4 is a sectional schematic diagram to explain the groove shape and pass sequence of joint of structural steel.

FIG. 5 is a graph showing the relationship between the amount of hydrogen concentration in a weld zone analyzed by a numerical analysis and the depth from the steel material surface through thickness direction.

FIGS. 6 (a) to 6 (c) show results of a simulation of the distribution of the hydrogen concentration in a weld zone analyzed by a numerical analysis.

### DESCRIPTION OF EMBODIMENT

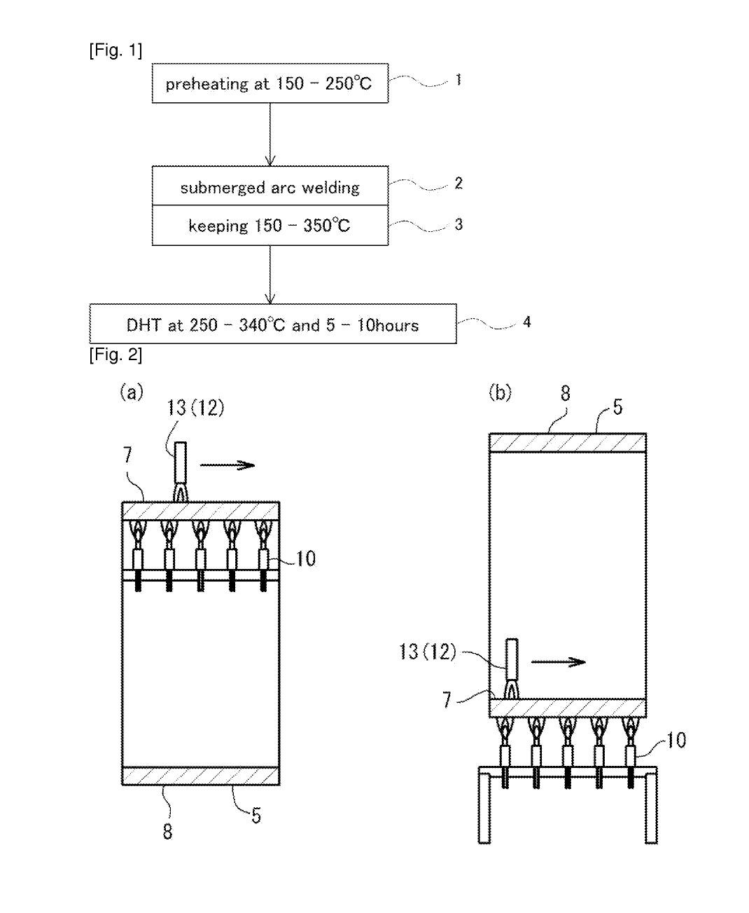

An embodiment of the present invention will be described below with reference to the drawings. FIG. 1 is a flowchart to explain the procedure for a method of welding structural steel in an embodiment of the present invention. The method of welding structural steel of the present invention includes a preheating step 1 of preheating structural steel, a welding step 2 of performing welding, a heating step 3 of performing heating to a prescribed temperature and of keeping the temperature, and a dehydrogenation heat treatment (DHT) step 4 of performing heat treatment after welding.

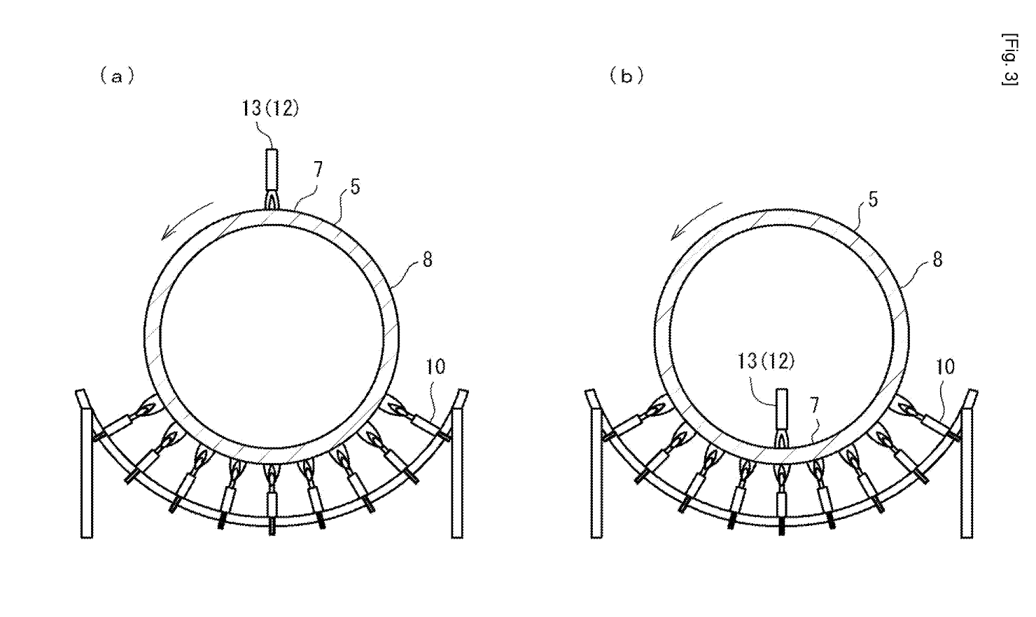

FIG. 2 (a) is a diagram showing an example in which the method of welding structural steel 5 of the present embodiment is applied to the longitudinal outer-side welding of the structural steel 5, and FIG. 2 (b) is a diagram showing an example in which the welding method is applied to the longitudinal inner-side welding of the structural steel 5. FIG. 3 (a) is a diagram showing an example in which the method of welding structural steel 5 of the present embodiment is applied to the circumferential outer-side welding of the structural steel 5, and FIG. 3 (b) is a diagram showing an example in which the welding method is applied to the circumferential inner-side welding of the structural steel 5. The structural steel 5 shown in the examples of FIGS. 2 (a) and 2 (b) and FIGS. 3 (a) and 3 (b) are steel for obtaining a cylindrical welded steel structure 8 with wall thicknesses of 50 to 350 mm, a diameter of 5000 mm, and a longitudinal length of 2500 mm as a pressure vessel. The structural steel to be joined by the welding method of the present invention, the size, shape, use and the like of a welded steel structure obtained from the structural steel and the like are not limited.

The structural steel 5 is made of a Cr—Mo—V steel material containing, by mass %, Cr: 1.5 to 3.5%, Mo: 0.5 to 1.5%, and V: 0.15 to 0.5%. The mass ratio of components of the Cr—Mo—V steel material is changed in the above-described range in such a manner as to adapt to use conditions and the like, components other than these components can be added, and other inevitable components are also contained.

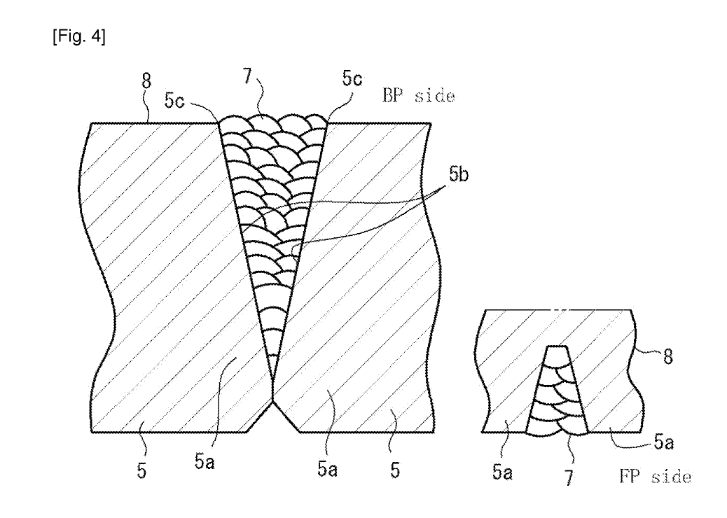

FIG. 4 is a sectional schematic diagram to explain the groove shape and pass sequence of structural steel 5. The structural steel 5 are shaped in such a manner that as in this embodiment, the groove shape becomes the letter X, for example. As the groove shape there are the I shape, the V shape, the Y shape, the single bevel shape, the K shape, the J shape, the U shape, the H shape and the like in addition to the X shape, and an optimum groove shape is selected according to welding conditions and the like. The groove depth, groove angle, groove width, root gap and the like on that occasion can be appropriately selected according to welding conditions and the like.

A prescribed groove shape is obtained by abutting two structural steel 5 against each other. After the two structural steel 5 are abutted against each other, the preheating step 1 is performed which involves preheating joint 5a at which the two structural steel 5 are to be welded. The joint 5a termed in the preheating step 1 refers to each end face 5b and the region of 100 mm or so inside the steel material from each side face 5c. Prior to welding, heat is applied by a gas burner and the like to the joint 5a and the joint 5a is preheated until the temperature becomes 150 to 250 degrees Celsius. If the preheating temperature is lower than 150 degrees Celsius, the degassing effect of diffusible hydrogen decreases and hardening occurs in an affected zone by the welding heat. If the preheating temperature is higher than 250 degrees Celsius, this may induce the coarsening of grains which causes the deterioration of the toughness of an affected zone by the welding heat.

Although the heat source of preheating is not limited, a gas burner, which can be used easily, is recommended in order to reduce production costs. An electric heater, an infrared heater, a halogen heater and the like may be used instead of a gas burner.

A submerged arc welding machine 12 is installed around the joint 5a of the structural steel 5. In the submerged arc welding (SAW) method, molten metal is protected by slag and, therefore, arcs are shut off from the outside air and are stable. In addition, the welding speed is high and the efficiency of welding is excellent. Moreover, the mechanical properties of a weld zone are good and low-temperature toughness is excellent. For this reason, this submerged arc welding method is used in a preferable manner in the present invention. Structural steel may be welded by welding method other than the submerged arc welding method. In the case of a Cr—Mo—V steel containing, by mass %, Cr: 1.5 to 3.5%, Mo: 0.5 to 1.5%, and V: 0.15 to 0.5%, which is used in this embodiment, welding is possible, for example, by the shielded metal arc welding (SMAW) method, the gas tungsten arc welding (GTAW) and the like.

The submerged arc welding machine 12 used in this embodiment is composed of a flux refilling machine, a wire feeding machine, a welding power source and the like. The flux refilling machine is provided with a flux hopper and a flux recovery unit. The wire feeding machine is provided with a welding wire, a wire reel, a wire feeding motor and the like. The welding power source is provided with a welding power supply, a torch 13 and the like. A current from the welding power supply flows from the torch 13 to the welding wire. An arc is generated in a groove formed in the joint 5a of the structural steel 5 and welding is performed using the arc. The torch 13 used on that occasion may be a single torch or a tandem torch. For example, in the case of a single torch, welding can be performed under the conditions; current: 450 to 650 A, voltage: 20 to 40 V, and welding speed: 25 to 50 cm/minute. In the case of a tandem torch, welding can be performed under the conditions; current: 450 to 650 A/450 to 650 A, voltage: 20 to 40 V/20 to 40 V, and welding speed: 50 to 80 cm/min.

In the longitudinal outer side welding shown in FIG. 2 (a), a plurality of gas burners 10 are installed on the inner side and joint 5a is preheated, whereas in the longitudinal inner side welding shown in FIG. 2 (b), a plurality of gas burners 10 are installed on the outer side and joint 5a is preheated. In the circumferential outer side welding shown in FIG. 3 (a), a plurality of gas burners 10 are installed on the inner circumferential side and joint 5a is preheated, whereas in the circumferential inner side welding shown in FIG. 3 (b), a plurality of gas burners 10 are installed on the outer circumferential side and joint 5a is preheated.

After the preheating step 1, in the welding step 2 the multilayer welding of the joint 5a is performed by the submerged arc welding machine 12. Welding conditions, such as the number of passes during the multilayer welding, are appropriately changed. In this embodiment, as shown in FIG. 4, welding was performed on the joint 5a of an X groove by 36 passes for BP (backing pass) side and 9 passes for FP (finishing pass) side. In the longitudinal outer side welding shown in FIG. 2 (a) and the longitudinal inner side welding shown in FIG. 2 (b), the torch 13 of the submerged arc welding machine 12 can be moved at a required welding speed along the longitudinal direction. In the circumferential outer side welding shown in FIG. 3 (a), the structural steel 5 can be turned at a required speed, with the torch 13 of the submerged arc welding machine 12 kept in a fixed condition. In the circumferential inner side welding shown in FIG. 3 (b), the structural steel 5 can be turned at a required speed, with the torch 13 of the submerged arc welding machine 12 kept in a fixed condition.

In addition to the welding step 2, also the heating step 3 is carried out in order to keep the interpass temperature of the joint 5a. In the heating step 3, the interpass temperature is kept by heating the joint 5a to the temperatures of 150 to 350 degrees Celsius. If the interpass temperature is lower than 150 degrees Celsius, the degassing effect of diffusible hydrogen decreases and hardening occurs in the affected zone by the welding heat. If the interpass temperature is higher than 350 degrees Celsius, this may induce the coarsening of grains which causes the deterioration of the toughness in the affected zone by the welding heat. If DHT is carried out, with a weld zone 7 kept at temperatures of not less than 150 degrees Celsius by introducing this heating step 3, a higher heat treatment effect can be obtained in the succeeding DHT step 4. Although the heat source for carrying out the heating step 3 is not limited, a gas burner 10, which can be used easily, is recommended in order to reduce production costs. An electric heater, an infrared heater, a halogen heater and the like may be used instead of a gas burner.

The flow of welding proceeds to the next DHT step 4, with the weld zone 7 kept at a prescribed temperature. The amount of diffusible hydrogen of the weld zone 7 can be substantially reduced by performing this DHT. It is preferred that the DHT be performed under the conditions that the temperature is 250 to 340 degrees Celsius and that the treatment time is 5 to 10 hours. The temperature of DHT is more preferably 260 to 310 degrees Celsius and the treatment time is more preferably 7 to 9 hours. If the DHT temperature is lower than 250 degrees Celsius, it is impossible to sufficiently reduce diffusible hydrogen. If the DHT temperature is higher than 340 degrees Celsius, the work is difficult to perform, because for example, heat treatment devices having sizes suited to members, such as an electric heater and a heat treatment furnace, become necessary, resulting in an increase in production costs. Furthermore, if the treatment time is shorter than 5 hours, it is impossible to sufficiently reduce diffusible hydrogen. If the treatment time is more than 10 hours, this leads to an increase in costs. Although the heat source for carrying out the DHT step 4 is not limited, a gas burner 10, which can be used easily, is recommended in order to reduce production costs. An electric heater, an infrared heater, a halogen heater and the like can be used instead of a gas burner.

As described above, the joint 5a of the structural steel 5 is subjected to the preheating step 1, the welding step 2, the heating step 3, and the DHT step 4, whereby it is possible to obtain a welded steel structure 8 which is strongly joined by a high-quality weld zone 7.

The present inventors developed a technique for analyzing the amount of diffusible hydrogen in a weld zone and carried out a diffusible hydrogen simulation of a weld zone 7 of this embodiment. In the diffusible hydrogen simulation, calculations are made by a heat conduction analysis and a mass diffusion analysis. In the heat conduction analysis, a temperature distribution by welding heat input and heat treatment is calculated. In the mass diffusion analysis, calculation results of the heat conduction analysis are incorporated and calculations are made using the following Fick's diffusion equation and formula of hydrogen supply:

Fick's diffusion equation: ∂φ/∂d=D·(∂²φ)/(∂x²)

φ: hydrogen concentration, t: time D: diffusivity, x: position

Formula of hydrogen supply: Ca=Ci+(B/(A+B))Cr

A: deposited metal (mm²), B: melting area (mm²),

Ci: initial hydrogen concentration (ppm),

Cr: residual hydrogen concentration of B (ppm),

Ca: averaged hydrogen concentration of A+B (ppm)

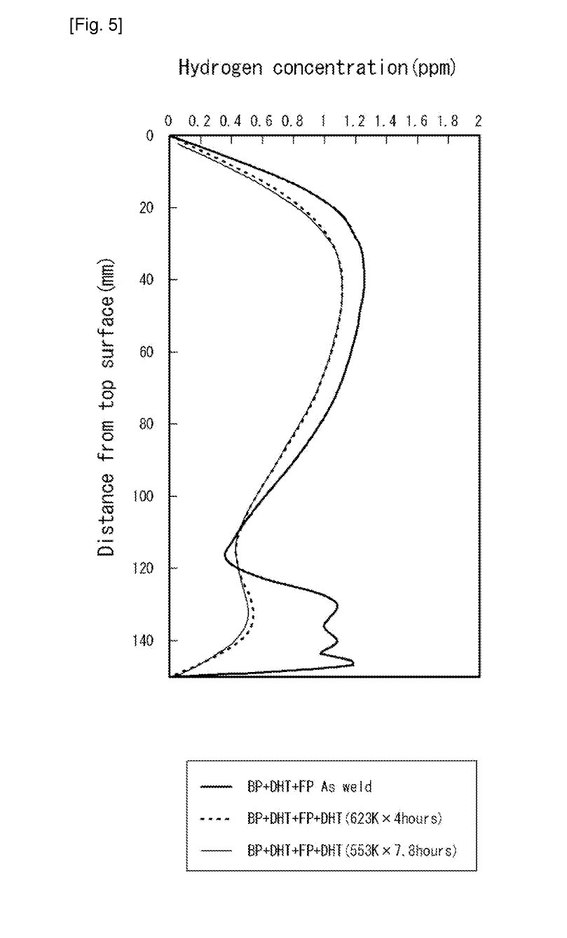

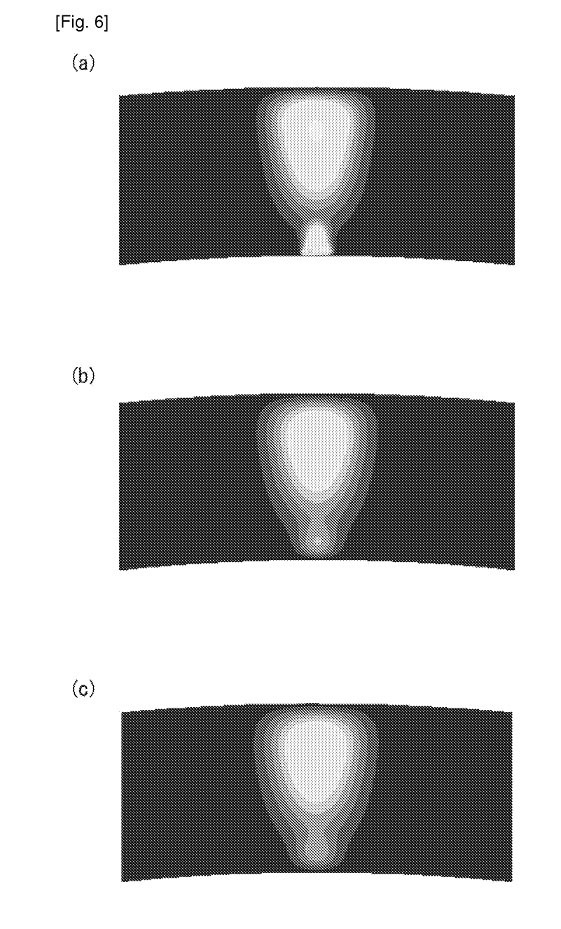

FIG. 5 is a graph showing the relationship between the amount of hydrogen concentration in a weld zone analyzed by a numerical analysis and the depth from the steel material surface through thickness direction, and FIGS. 6 (a) to 6 (c) show results of a simulation of the distribution of the hydrogen concentration. FIG. 6 (a) shows a sample without DHT, FIG. 6 (b) shows a sample whose BP side was subjected to DHT at 350 degrees Celsius for 4 hours in accordance with the API standard and whose FP side was subjected to DHT at 350 degrees Celsius for 4 hours, and FIG. 6 (c) shows a sample whose BP side was subjected to DHT at 280 degrees Celsius for 7.8 hours and whose FP side was subjected to DHT at 280 degrees Celsius for 7.8 hours. As is apparent from FIG. 5 and FIGS. 6 (a) to 6 (c), the condition of the amount of diffusible hydrogen is almost the same in the sample whose BP side was subjected to DHT at 350 degrees Celsius for 4 hours in accordance with the API standard and whose FP side was subjected to DHT at 350 degrees Celsius for 4 hours, and the sample whose BP side was subjected to DHT at 280 degrees Celsius for 7.8 hours and whose FP side was subjected to DHT at 280 degrees Celsius for 7.8 hours.

In this embodiment, in a weld zone 7 of welded steel structures 8 subjected to DHT under the conditions that the temperature is 250 to 340 degrees Celsius and that the treatment time is 5 to 10 hours, an analysis of the amount of diffusible hydrogen was carried out by the above-described technique. The amount of diffusible hydrogen was the same with those of the samples subjected to DHT in accordance with the API standard or smaller than those amounts.

According to the method of welding structural steel 5 and welded steel structure 8 of the above-described embodiment, the preheating step 1 of preheating joint 5a at temperatures of 150 to 250 degrees Celsius is introduced before the welding step 2 of performing welding by submerged arc welding, the heating step 3 of keeping the interpass temperature during multilayer welding at 150 to 350 degrees Celsius is introduced, and when a weld zone 7 kept at temperatures of not less than 150 degrees Celsius is subjected to DHT, the heat treatment is performed under the conditions that the temperature is 250 to 340 degrees Celsius and that the treatment time is 5 to 10 hours. Therefore, when DHT is performed, it is possible to perform heating and heat treatment using a gas burner 10, for example. For this reason, heat treatment devices, such as a large electric heater and a heat treatment furnace, become unnecessary. In addition, the process can be simplified. As a result of this, it is possible to reduce production costs.

Furthermore, because a weld zone 7 kept at temperatures of not less than 150 degrees

Celsius is subjected to DHT, it is possible to accelerate the diffusion of hydrogen to a greater extent, and at the same time, the hardening of an affected zone by the welding heat is prevented, with the result that the suppressing effect of the cold cracking of the weld zone 7 can be increased.

This embodiment disclosed above is illustrative of a method of welding structural steel and a welded steel structure of the present invention, and the method of welding structural steel may include other steps. Also the configuration of the welded steel structure is not limited.

1. A method of welding structural steel containing, by mass %, Cr: 1.5 to 3.5%, Mo: 0.5 to 1.5%, and V: 0.15 to 0.5%, comprising:
preheating joint of the structural steel to be welded at temperatures of 150 to 250 degrees Celsius;
multilayer welding the joint;
keeping the interpass temperature of the joint during the multilayer welding at 150 to 350 degrees Celsius; and
performing dehydrogenation heat treatment by heat treating the weld zone kept at temperatures of not less than 150 degrees Celsius under the conditions that the temperature is 250 to 340 degrees Celsius and that the treatment time is 5 to 10 hours.

2. The method of welding structural steel according to claim 1, wherein the welding is performed by the submerged arc welding method for a butt joint.

3. A welded steel structure obtained by welding steel structures containing, by mass %, Cr: 1.5 to 3.5%, Mo: 0.5 to 1.5%, and V: 0.15 to 0.5%, wherein joint of the structural steel preheated to temperatures of 150 to 250 degrees Celsius is multilayer welded at interpass temperature of 150 to 350 degrees Celsius and a resulting weld zone is subjected to dehydrogenation heat treatment under the conditions that the temperature is 250 to 340 degrees Celsius and that the treatment time is 5 to 10 hours.

4. The welded steel structure according to claim 3, wherein the welded steel structure is formed as a pressure vessel in the shape of a cylinder with wall thicknesses of 50 to 350 mm.
